(19) United States
(12) Patent Application Publication
(10) Pub. No.: US 2025/0072423 A1
(43) Pub. Date: Mar. 6, 2025

(54) THIOPHENE ACETIC ACID FOR PLANT GROWTH REGULATION

(71) Applicant: United Arab Emirates University, Al Ain (AE)

(72) Inventors: Suja GEORGE, Al Ain (AE); Khaled M.A. AMIRI, Al Ain (AE); Mohammed RAFI, Al Ain (AE); Maitha ALDARMAKI, Al Ain (AE); Mohamed ELSIDDIG, Al Ain (AE); Mariam ALNUAIMI, Al Ain (AE)

(21) Appl. No.: 18/737,301

(22) Filed: Jun. 7, 2024

Related U.S. Application Data
(63) Continuation-in-part of application No. 18/238,934, filed on Aug. 28, 2023, now Pat. No. 12,029,216.

(51) Int. Cl. A01N 43/90; A01N 43/10; A01P 21/00

(52) U.S. Cl. CPC A01N 43/90; A01N 43/10; A01P 21/00

(57) ABSTRACT

The present disclosure concerns a plant growth regulator comprising thiophene acetic acid. The present disclosure also concerns a method of regulating growth of plants, the method comprising preparing a plant growth regulator comprising thiophene acetic acid and contacting the plants with the plant growth regulator.

### CROSS-REFERENCE TO RELATED APPLICATIONS

This application claims the benefit of U.S. patent application Ser. No. 18/238,934, filed on Aug. 28, 2023, the entire contents of which are specifically incorporated by reference herein.

### FIELD

The present disclosure concerns plant growth regulation. More particularly, but not exclusively, the present disclosure concerns thiophene acetic acid for plant growth regulation.

### BACKGROUND

Background description includes information that will be useful in understanding the present invention. It is not an admission that any of the information provided herein is prior art or relevant to the presently claimed invention, or that any publication specifically or implicitly referenced is prior art.

Plant growth regulators (PGRs) are natural or synthetic substances that help regulate plant growth and develop and include hormones and synthetic hormone analogues. PGR products are used in various industries such as agriculture, viticulture, and horticulture to improve plant growth and crop yield under non-ideal soil and environmental conditions. PGRs, especially auxins, and cytokinins are useful in vitro micro propagation of plants.

PGRs are commonly used in tissue culture to propagate multiple plants from a few explants. Similarly, they are used for the efficient regeneration of transgenic plants from explants after genetic transformation to develop modified plants with desirable traits. In the field, PGRs are often used to accelerate root and shoot growth and in turn, enhance yield. Plant hormones auxins and cytokinins are commonly used as PGRs.

To date, only a small number of auxins and cytokinins are commonly used in experiments involving in vitro regeneration. Examples of such auxins includes naturally occurring auxins indole-3-acetic acid (IAA), indole-3-butyric acid (IBA), 4-chloroindole-3-acetic acid (4-CI-IAA), and phenylacetic acid (PAA), and synthetic auxins naphthalene-1-acetic acid (NAA), 2,4-dichlorophenoxyacetic acid (2,4-D), and picloram, which are used in plant tissue culture.

However, a good regeneration protocol that works for one genotype would often require considerable modifications, especially in the case of hormones and their combinations, for different genotypes of the same species.

There is a need to identify new PGRs in order to develop new hormonal combinations for the efficient regeneration of different genotypes and recalcitrant species in vitro and for enhancing the growth of different species in the field.

The present disclosure seeks to mitigate at least one of the abovementioned problems. More particularly, but not exclusively, the present disclosure seeks to provide a new PGR.

### SUMMARY

According to a first aspect of the present disclosure, there is provided a plant growth regulator composition for regulating the growth of roots and shoots of explants with an auxin response pathway in vitro comprising thiophene acetic acid.

The inventors have surprisingly found that thiophene acetic acid (TAA) performs particularly well as a plant growth regulator. TAA was surprisingly found to enhance root and shoot formation and growth in explants. TAA was surprisingly found to enhance root and shoot formation in cotyledon and leaf explants. TAA is also advantageous in that it may be used to enhance growth in whole plants.

The explants may be cotyledon or leaf explants.

In embodiments of the present disclosure, TAA may be beneficial in regulating growth of plants by inhibiting growth. The plant growth regulator may be a plant growth-inhibitor.

The thiophene acetic acid may be thiophene-3-acetic acid. The thiophene acetic acid may be thriophene-2-acetic acid. The thiophene acetic acid may be a combination of both thiophene-2-aceitc acid and thiophene-3-acetic acid.

The plant growth regulator composition may be suitable for plants with an auxin response pathway.

It has been found by the inventors, through experimentation on different plants with auxin response pathways belonging to different plant families, that TAA behaves as an auxin analog. Since TAA has been found to be an auxin analog, it is surprisingly beneficial that TAA is a beneficial component of a plant growth regulator composition for regulating the growth of plants that have an auxin response pathway.

The plant growth regulator composition may be suitable for one or more of the plant families Solanaceae or Brassicaceae.

The plant families Solanaceae or Brassicaceae may have an auxin response pathway. It has been found by the inventors that plants belonging to these plant families have an auxin response pathway that responds to TAA.

The plant growth regulator may be suitable for tomato plants. The plant growth regulator composition may be suitable for tobacco. The plant growth regulator composition may be suitable for Arabidopsis.

The inventors discovered that shoot regeneration from tomato cotyledon explants in vitro was enhanced in the presence of the antibiotic timentin. The inventors also discovered that timentin degrades into thiophene acetic acid (TAA) over time.

The plant growth regulator may be a plant growth-promoter.

The plant growth regulator composition may be a plant growth regulator composition for regenerating the roots and shoots of explants with an auxin response pathway.

The plant growth regulator composition may comprise 6-benzylaminopurine (BAP). The plant growth regulator may comprise cytokinins. The plant growth regulator may comprise kinetin. The plant growth regulator may comprise zeatin.

The addition of BAP has been found to have a synergistic effect with TAA. For example, shoot regeneration when enhanced with a combination of TAA and BAP may exceed other know auxins.

The concentration of 6-benzylaminopurine (BAP) may be between 0.5 mg/L and 2.0 mg/L. The concentration of BAP may be between 0.75 mg/L and 1.25 mg/L. The concentration of BAP may be substantially 1 mg/L. Substantially 1 mg/L corresponds to greater or equal to 0.95 mg/L and less than 1.05 mg/L.

The concentration of thiophene acetic acid may be greater than 0.05 mg/L. It has been found by the inventors that TAA is effective as a plant growth regulator even at relatively low concentrations.

The concentration of thiophene acetic acid may be between 0.05 mg/L and 50 mg/L. The concentration of thiophene acetic acid may be between 0.5 mg/L and 25 mg/L. The concentration of thiophene acetic acid may be between 1 mg/L and 15 mg/L. The inventors found that at this concentration range, the TAA outperformed other known auxins under the same conditions.

The concentration of thiophene acetic acid may be between 8 mg/L and 12 mg/L. At this concentration range other known auxins cease to be effective at shoot regeneration for example, while TAA approaches a very high effectiveness in shoot regeneration for example.

The plant growth regulator composition may comprise BAP.

The concentration of the BAP may be between 0.5 mg/L and 2 mg/L.

The inclusion of BAP has been found to enhance the effectiveness of the plant growth attributes of the TAA.

The explants may belong to one or more of the plant families Solanaceae or Brassicaceae. The explants may be one or more of Solanaceae explants or Brassicaceae explants.

According to a second aspect of the present disclosure, there is provided a method of regulating growth of roots and shoots of explants with an auxin response pathway, the method comprising: preparing a plant growth regulator composition comprising thiophene acetic acid according to the first aspect; and contacting the explants and the plant growth regulator composition in vitro.

The explants may be plants with an auxin response pathway.

The explants may belong to one or more of the plant families Solanaceae or Brassicaceae.

The explants may be tomato explants. The explants may be tobacco explants. The explants may be Arabidopsis.

The preparing may comprise forming a culture media comprising the plant growth regulator composition.

The concentration of thiophene acetic acid may be greater than 0.05 mg/L.

The contacting may comprise placing the explants in the culture media.

The plant growth regulator may be supplemented to the culture media. In embodiments of the present disclosure, the explant is situated on the culture media such that it is allowed to develop.

It has been found that TAA is beneficial for regeneration, and as such it may be beneficial for example, for the regeneration of transgenic plants from explants after transformation. This is an important step in developing genetically modified plants with desirable traits.

The culture media may comprise Murashige and Skoog (MS) medium. The culture media may comprise sucrose gelled with agar.

The preparing may comprise forming a solution comprising the plant growth regulator composition such that the concentration of thiophene acetic acid is greater than 0.05 mg/L. The applying may comprise applying the solution comprising the plant growth regulator composition to plants.

TAA may also, for example, provide beneficial plant growth regulation properties when applied to plants in the field. The plants in the field may be whole plants.

The applying may comprise watering the plants with the solution as a foliar spray.

According to a third aspect of the present disclosure there is provided a method of regulating growth of roots and shoots of plants with an auxin response pathway, the method comprising: preparing a plant growth regulator composition comprising thiophene acetic acid according to the first aspect; and watering the explants with a solution comprising the plant growth regulator composition.

According to a fourth aspect of the present disclosure, there is provided a fertilizer for regulating growth of roots and shoots of plants with an auxin response pathway, the fertilizer comprising a plant growth regulator composition according to the first aspect.

It will be appreciated that features disclosed in relation to one aspect of the present disclosure may be used in combination with another aspect of the present disclosure, and vice versa.

### BRIEF DESCRIPTION OF THE DRAWINGS

The manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 shows a method of obtaining thiophene acetic acid according to an embodiment of the present disclosure;

FIG. 2 shows a chart showing the degradation of ticarcillin into TAA according to an embodiment of the present disclosure;

FIG. 3 shows a table of results of an experiment according to an embodiment of the present disclosure;

FIG. 4 shows a table of results of an experiment according to an embodiment of the present disclosure;

FIG. 5a shows a method of regulating plant growth according to an embodiment of the present disclosure;

FIG. 5b shows a method of regulating plant growth according to an embodiment of the present disclosure;

FIG. 6 shows a plant growth regulator according to an embodiment of the present disclosure;

FIG. 7 shows a fertiliser according to an embodiment of the present disclosure;

FIG. 8a shows a dose-response curve for primary root length of Arabidopsis according to an embodiment of the present disclosure;

FIG. 8b shows the effect of TAA on root gravitropism according to an embodiment of the present disclosure;

FIG. 8c shows expression levels of seven Arabidopsis early auxin-responsive genes under treatment with TAA according to an embodiment of the present disclosure; and

FIG. 8d shows comparison of primary root length of Arabidopsis seedlings upon treatment according to an embodiment of the present disclosure.

The foregoing and other objects, features and advantages of the present invention, as well as the invention itself, will be more fully understood from the following description of preferred embodiments, when read together with the accompanying drawings.

### DETAILED DESCRIPTION

The present disclosure relates to the field of plant growth regulation, and more particularly to the use of thiophene acetic acid for plant growth regulation.

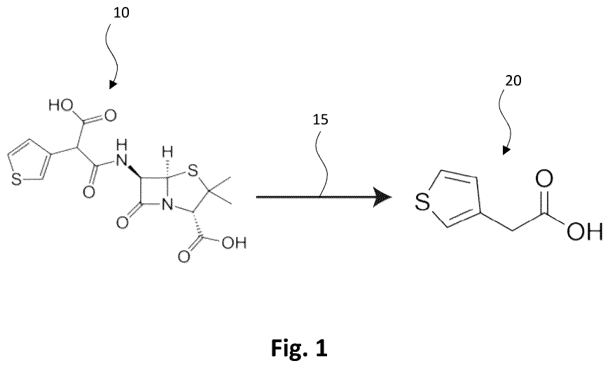

The principles of the present invention and their advantages are best understood by referring to FIG. 1 to FIG. 8d. In the following detailed description of illustrative or exemplary embodiments of the disclosure, specific embodiments in which the disclosure may be practiced are described in sufficient detail to enable those skilled in the art to practice the disclosed embodiments. The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

Plant growth and development are regulated by various phytohormones such as auxins, cytokinins, gibberellins, ethylene, and abscisic acid. The phytohormone auxin plays important roles in different developmental stages of plants including organogenesis, root initiation, vascular tissue differentiation, tropism, apical dominance, fruit formation, leaf abscission, and senescence. On a cellular level, auxins regulate cell expansion, division, and differentiation. Additionally, the auxin signaling pathway interacts with the signaling pathways of other phytohormones thus influencing almost all plant development processes, including responses to abiotic stress, pathogens, etc, directly or via cross-talk.

Indole-3-acetic acid (IAA), a simple molecule consisting of an indole ring and a carboxylic acid side chain, structurally similar to the amino acid tryptophan is considered as an auxin. The term auxin also comprises those compounds that can elicit a response analogous to what IAA does. IAA is the most common naturally occurring auxin in plants. Other naturally occurring auxins are indole-3-butyric acid (IBA), 4-chloroindole-3-acetic acid (4-Cl-IAA), and phenylacetic acid (PAA). Considering the important role of auxins in plant growth and development, various synthetic auxin analogs have been designed to mimic endogenous auxins for use in horticulture, agriculture, tissue culture, and research. Naphthalene-1-acetic acid (NAA), 2,4-dichlorophenoxyacetic acid (2,4-D), and picloram are considered to be synthetic auxin-analogs.

FIG. 1 shows a method of obtaining thiophene acetic acid according to an embodiment of the present disclosure.

Ticarcillin 10 is the main component of the antibiotic timentin. Ticarcillin 10 degrades 15 naturally over time into thiophene acetic acid (TAA) 20. Thiophene acetic acid is characterized by the thiophene ring, connected to which, is an acetic acid group. The acetic acid group is connected to the thiophene ring in the 3 position i.e. the embodiment of FIG. 1 shows thiophene-3-acetic acid 20.

In embodiments of the present disclosure, the ticarcillin degrades into thiophene-2-acetic acid. In embodiments of the present disclosure, the ticarcillin degrades into both thiophene-2-acetic acid and thiophene-3-acetic acid.

A plant growth regulator of embodiments of the present disclosure comprises TAA. In embodiments, the plant growth regulator comprises a single isomer of TAA. In embodiments, the plant growth regulator comprises thiophene-2-acetic acid. In embodiments, the plant growth regulator comprises thiophene-3-acetic acid. In embodiments, the plant growth regulator comprises both thiophene-2-acetic acid and thiophene-3-acetic acid.

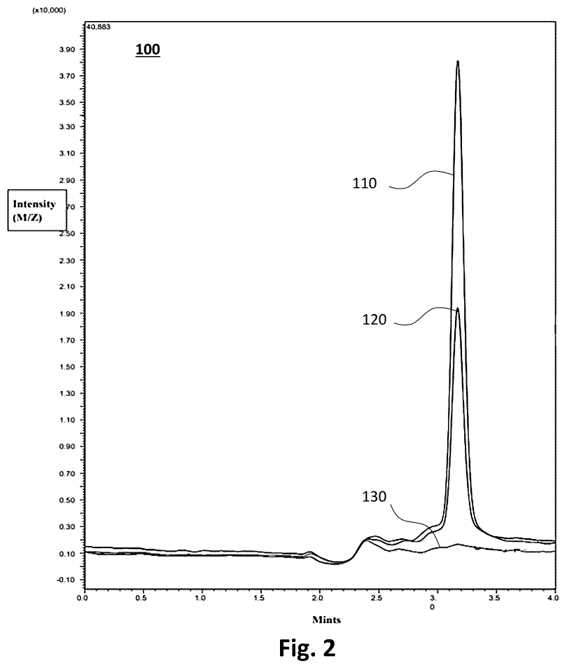

FIG. 2 shows a chart 100 showing the degradation of ticarcillin into TAA according to an embodiment of the present disclosure. The chart 100 depicts the results of the following experiment 1:

### Plant Material and Growth Conditions

Seeds of tomato cultivar Roma VF were sterilized by treating with 75% ethanol for 30 seconds at room temperature and washed with sterile water for five times. The seeds were then treated with 15% sodium hypochlorite for 10 minutes and washed five times in sterile water. The sterilized seeds were germinated on half-strength Murashige and Skoog (MS) medium in vitro. Cotyledons from 10-day old seedlings before first true leaves emerged were used as starting explants in all the experiments. The base and tip of the cotyledons were excised and the explants were transferred with the abaxial surface in contact with the culture medium. The basic culture medium consists of MS medium with vitamins supplemented with 30 g/L sucrose and gelled with 0.8% agar, and the pH of the medium was adjusted to 5.8±0.2. Plates were maintained at a light cycle of 16/8 hours day/night, temperature of 26/24° C. day/night, and relative humidity of 70% and subcultured on the same media after 14 days. Observations were made on 7, 14, 21 and 28 days of growth. All experiments were conducted with at least three replicates of 10 explants each.

Tomato belongs to the plant family Solanaceae. It is believed that although tomato is an exemplary plant, other plants belonging to the family Solanaceae will also respond to TAA as they have similar auxin response pathways. Other plants will be described herein demonstrating that TAA is usable as a plant growth regulator for a number of different plants with an auxin response pathway.

### Experiment 1

The Liquid Chromatography with tandem mass spectrometry (LC-MS/MS) analysis was carried out using a tandem mass spectrometer connected in tandem to an ultra-high-pressure liquid chromatography (UHPLC) system, consisting of a binary pump, auto-sampler, column compartment, DAD detector and degasser. The mass spectrometer was operated in both positive and negative electrospray ionization (ESI) modes. Nitrogen was used as heating and drying gases for samples.

The following samples were analysed for the presence of TAA; timentin 300 mg/L solution in sterile deionized water (0 and 28 day old), tomato cotyledon grown in the presence and absence of 300 mg/L timentin in basic culture media (0, 14 and 28 day old). The timentin solution in sterile deionized water was diluted further to prepare timentin 1 mg/L working solution and 10 μL was injected. The plant samples were powdered in liquid nitrogen and 0.5 g of the sample was weighed and mixed with 0.5 mL of deionized water. The sample was vortexed for 5 mins. This was followed by the addition of a solution of 5.0 mL of 1% formic acid in methanol, vortexed mixed, and centrifuged for 5 mins at 2000×g (4° C.). After that, the supernatant was filtered with a disposable membrane filter of 0.45 μm pore size. Finally, 10 μL of the filtrate was injected into the LC-MS/MS system for analysis.

The LC-MS/MS analysis revealed that TAA was not present in the freshly prepared solution of 300 μg/mL timentin in water. However, after 14 and 28 days, TAA was detected in the samples, indicating that ticarcillin had degraded into TAA during that time. In plant samples grown without timentin, no TAA was detected in samples that were 0, 14, or 28 days old. On the other hand, in samples grown with timentin, 4.6 μg/mL TAA was detected in 14-day-old samples and 2.1 μg/mL was detected in 28-day-old samples. These findings confirm that ticarcillin degrades into TAA over time, which explains its presence in the plant samples (FIG. 2).

The results of FIG. 2 depict the results of this analysis. The line 130 shows the mass spectrometry chromatogram at 0 days, indicating that there is no TAA present in the freshly prepared solution. The line 110 is the peak at 14 days, and the line 120 is the peak at 28 days. This demonstrates that ticarcillin, the main component of timentin, degrades into TAA over time.

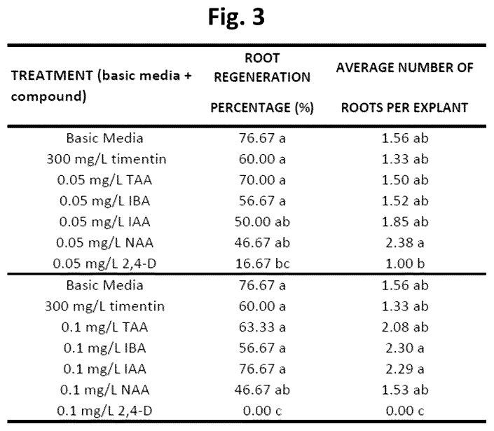

FIG. 3 shows a table of results of an experiment according to an embodiment of the present disclosure. The table of FIG. 3 corresponds to the results of Experiment 2, which is as follows:

### Analysis of Effect of TAA and Commonly Used Auxins on Root Regeneration

In order to analyze the effect of TAA on root regeneration, the basic media were supplemented with different concentrations of TAA (0.05 and 0.1 mg/L) and further compared with individual effect of widely used auxins (IAA, NAA, IBA, 2,4 D) at similar concentrations.

### Results of Experiment 2

The individual effects of TAA and commonly used auxins, IAA, NAA, IBA and 2,4D at two different concentrations (0.05 and 0.1 mg/L) on organogenesis from tomato cotyledon explants in basic culture media in the absence of any other hormones was analysed. Except 2,4 D, all the other hormones showed rapid root formation at both the concentrations within 7 days. Under both 2,4D concentrations, the explants enlarged in size and started showing signs of callus formation. Few explants showed tiny roots. By Day 14, explants on 2,4D containing media formed more callus and few of the explants showed longer roots.

The explants on other compounds containing media showed rapid root growth after Day 7. FIG. 3 shows that TAA performs on par with most known auxins for root regeneration, and is at least a viable alternative to known auxins.

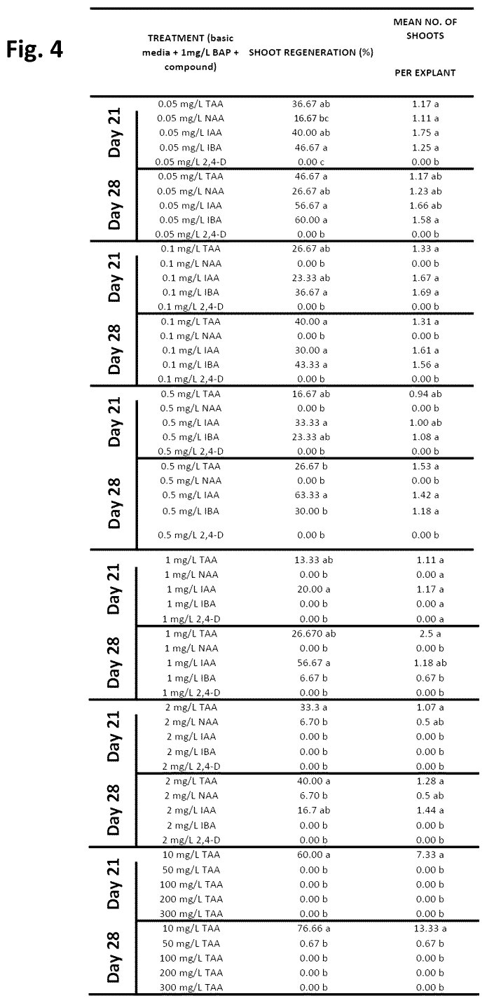

FIG. 4 shows a table of results of an experiment according to an embodiment of the present disclosure. The table of FIG. 4 corresponds to the results of Experiment 3, which is as follows:

### Analysis of Effect of TAA and Commonly Used Auxins on Shoot Regeneration

To analyse the effects on shoot regeneration, the basic media was supplemented with 1 mg/L BAP and different concentrations of TAA, IAA, NAA, IBA and 2,4 D (0.05, 0.1, 0.5, 1.0 and 2.0 mg/L) individually. Since there are no previous reports on suitable concentration ranges for TAA in tomato regeneration, concentrations at 50.0, 100.0, 200.0 and 300.0 mg/L were analysed additionally for TAA.

### Results of Experiment 3

To analyse the effect of TAA and different auxins on shoot organogenesis, different concentrations of TAA, IAA, NAA, IBA and 2,4D (0.05, 0.1, 0.5, 1.0 and 2.0 mg/L) along with 1 mg/L BAP were analysed. In addition, the effect of higher concentrations of TAA (10.0, 50.0, 100.0, 200.0 and 300.0 mg/L) on shoot organogenesis was analysed. Shoot growth was observed only at low concentration of NAA (0.05 mg/L). At this concentration, most explants produced callus, but a few produced shoots. Higher concentrations of NAA produced mostly callus by Day 28, but a few of them showed root formation. IAA showed better shoot formation than NAA at 0.05, 0.1, 0.5 and 1.0 mg/L in combination with 1 mg/L BAP. The shoots at Day 28 were large and well defined. As the concentration of IAA increased, the number of explants with callus formation increased and at 2 mg/L, the plates showed mostly callus and root formation. Similar to IAA, IBA showed callus and well-defined shoot formation at lower concentrations (0.05, 0.1 and 0.5 mg/L) when used in combination with 1 mg/L BAP and at higher concentrations (1.0 and 2.0 mg/L), showed mostly callus and some root formation. 2,4D did not show any shoot formation at any of the concentrations (0.05, 0.1, 0.5, 1.0 and 2.0 mg/L) when used in combination with 1 mg/L BAP. The explants produced calluses at all concentrations. Lower concentrations of TAA (0.05, 0.1, 0.5, 1.0, 2.0 and 10.0 mg/L) started showing shoot formation around day 14 and many explants had well defined shoots by Day 28.

TAA at 10.0 mg/L showed the maximum number of shoots, and in fact, TAA at 10.0 mg/L showed greater shoot regeneration than any other tested auxin at any other concentration. Higher concentrations of TAA (50.0, 100.0 and 200.0 mg/L) did not show any shoot or root formation, instead showed callus formation. At 300 mg/L TAA, the explants showed necrosis within 7 days and by Day 28, all explants were dead.

The results shown in FIG. 4 demonstrate that TAA is a viable auxin analogue and facilitates the possibility of new combinations in new concentration regimes.

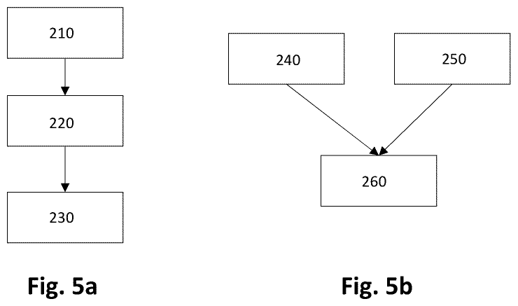

FIG. 5a shows a method of regulating plant growth according to an embodiment of the present disclosure.

Step 210 refers to a step of cultivating an explant. The step of cultivating comprises selecting seeds of the selected plant. The seeds are then treated and washed. The seeds are then germinated on a medium in vitro. Cotyledons from 10-day old seedlings before first true leaves emerge are used as starting explants.

In embodiments of the present disclosure, the treating of the seeds involves sterilization in 75% ethanol. In embodiments of the present disclosure, the treating of the seeds comprises treatment with 15% sodium hypochlorite.

Step 220 refers to the step of preparing the culture media. The preparation of the culture media starts with preparing half-strength Murashige and Skoog (MS) medium. The germination medium is also supplemented with vitamins, supplemented with 30 g/L sucrose, and gelled with 0.8% agar.

Step 230 refers to the step of placing the explant in the culture media. Placing the explant in the culture media may also be known as introducing the explant to the culture media.

Step 230 comprises excising the base and tip of the cotyledons. The explants are transferred with the abaxial surface in contact with the culture medium.

FIG. 5b shows a method of regulating plant growth according to an embodiment of the present disclosure.

Where the method of FIG. 5a related to treatment of explants, the method of FIG. 5b relates to the treatment of whole plants, according to an embodiment of the present disclosure.

The treatment of whole plants may be approached from one of two routes. The first is the preparation of a liquid solution that is then used to treat and nourish the plant. The second is the preparation of a fortified compost that is used to grow the plant.

Step 240 relates to the step for preparation of solution of plant growth regulator comprising TAA. TAA and other vitamins, nutrients, auxins, and plant hormones selected for the desired plant growth regime is diluted in water to the desired concentrations to obtain the solution. The plant growth regulator solution applied to the whole plants in the field in step 260. The means of application can range from industrial machinery, to sprinklers, to sprays, to watering cans, for example. The application may be a spray onto the leaves of the plant, for example. In another use, the seedlings or cuttings may be treated with a liquid solution of plant growth regulator comprising TAA before being planted in the soil to enhance rooting, for example.

Step 250 relates to the step for preparation of compost comprising plant growth regulator comprising TAA. TAA and other vitamins, nutrients, auxins, and plant hormones selected for the desired plant growth regimes are mixed into the compost at the desired concentration. The compost is applied to whole plants in the field in step 260. The application of the compost, in embodiments, comprises sprinkling the compost onto the topsoil of the field. In embodiments of the present disclosure, the application of the compost comprises mixing the compost with the topsoil of the field.

Both steps 240 and 250 may more generally be termed as preparing the plant growth regulator.

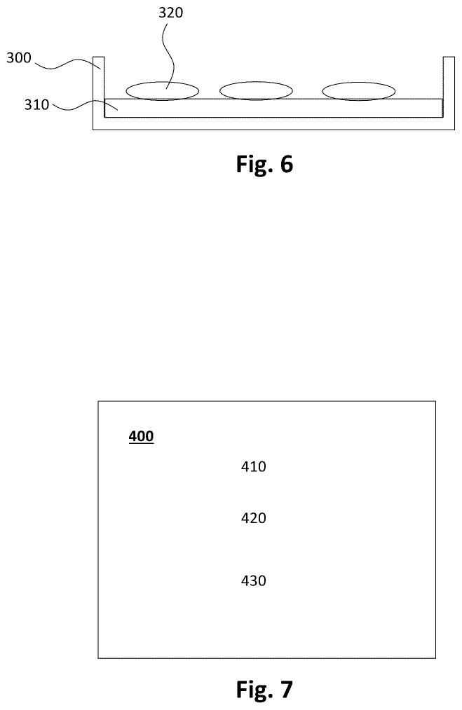

FIG. 6 shows a plant growth regulator 310 according to an embodiment of the present disclosure. The plant growth regulator 310 comprises culture media and thiophene acetic acid. The plant growth regulator 310 is positioned in a petri dish 300 such that it is suitable for cultivating explants 320 in a controlled environment.

In embodiments of the present disclosure, the explants 320 originate from tomato plants/seeds, tobacco plants/seeds, and/or Arabidopsis plants/seeds. Other explants belonging to plants that exhibit an auxin response pathway may be suitable, for example.

FIG. 7 figuratively shows a fertiliser 400 according to an embodiment of the present disclosure.

The fertiliser 400 comprises TAA 410, compost 420, and other additives 430. The other additives 430 may comprise vitamins, minerals, nutrients, plant hormones, or auxins, for example. In embodiments of the present disclosure, the other additives 430 comprise BAP.

The fertilizer 400 would be applied to whole plants in the field either by application to the topsoil, or by mixing into the topsoil and/or the soil beneath.

### Analysis of the Effect of TAA on Tobacco

Tobacco belongs to the plant family Solanaceae (like tomatoes). The inventors have investigated the effect of TAA on the regulation of tobacco, supporting the assertion that TAA is suitable for plant growth regulation for plants across an entire plant family.

The presence and ratio of phytohormones in tissue culture medium influence organogenesis. Exogenous auxin leads to pericycle cell division, from which founder cells emerge. An auxin-rich environment can cause these founder cells to undergo further cell division to form genetically distinct calluses. Organogenesis from calluses depends on auxin-cytokinin ratio in the media with a high-cytokinin to low-auxin ratio leading to shoot organogenesis, while the opposite will lead to root organogenesis.

### Experiment 4 Materials and Method

Nicotiana tabacum L. cv. Petit Havana SRI wild type (WT) seeds were sterilized and germinated using the same protocol as Arabidopsis (as described in the below description).

The effect of TAA was analyzed on in vitro organogenesis in tobacco alone and in combination with a cytokinin. IAA (Indole-3-acetic acid) was used as a positive control for this experiment. Root regeneration and minor shoot regeneration were observed when tobacco leaf explants were cultured on 3% MS media in the absence of any phytohormones for 8 weeks.

To analyze the effect of TAA on root regeneration in vitro, 3% MS media was supplemented with 1.0 mg/l TAA and regeneration was compared with that of explants grown on 3% MS media that was supplemented with 1.0 mg/l IAA. 3% MS media without any phytohormones was used as a control.

To analyze the effect of TAA on tobacco shoot organogenesis in vitro, shoot regeneration media (TB-SR (tobacco-shoot regeneration): 3% MS media+2 mg/L Kinetin) was used as control, and percentage of shoot regeneration was compared to that of TB-SR supplemented with different concentrations of TAA (1, 2, 3 and 5 mg/L) or IAA (1 mg/L). Plates were maintained at a light cycle of 16/8 hours day/night, temperature of 26/24° C. day/night, and relative humidity of 70% and subcultured on the same media after 14 days. After 8 weeks of growth, the number of well-formed shoots of at least 5 mm in length was measured. All experiments were conducted twice with at least three replicates of 7 explants each.

### Experiment 4 Results

To analyze the effect of TAA on shoot regeneration, 3% MS media was used supplemented with 2 mg/L of the cytokinin, kinetin, as the basic shoot regeneration media. Tiny shoots regenerated when tobacco leaf explants were grown in this media for 8 weeks. The average number of shoots per explant was 3.10 and the total number of shoots regenerated per plate was 21.7. Addition of 1 mg/L IAA to this basic media increased the number of shoots regenerated per explant and the total number of shoots regenerated by more than 3 times. The shoots appeared much bigger and well-formed compared to those regenerated in basic shoot regeneration media. Addition of TAA also had a positive effect on shoot regeneration and the size of regenerated shoots.

At both 1 and 2 mg/L TAA the number of shoots regenerated per explant and the total number of shoots regenerated were 3 times more than that grown in basic shoot regeneration media. Higher concentrations of TAA (3 mg/L and 5 mg/L) reduced the number of regenerated shoots, but still resulted in more than double compared to those regenerated in basic shoot regeneration media.

### Experiment 5 Materials and Method

Reporter genes under the control of auxin response elements (AuxRE) have been used as a method for indirect visualization of auxin in vivo based on its action. In transgenic Arabidopsis carrying GUS (beta-glucuronidase) reporter gene under the control of AuxREs, GUS expression was induced in the root elongation zone by active auxins such as IAA, NAA, 2,4-D and IBA, but not by inactive auxin analogues, IAA metabolic precursors, IAA transport inhibitors, or phytohormones. Artificial auxin-response promoter DR5 that contains a minimal 35S promoter fused to 9 repeats of an AuxRE with strict auxin specificity and responsive to only active auxins is used to indirectly visualize auxin in plants. Immunolocalization experiments show that the activity of DR5 correlates with auxin accumulation in Arabidopsis.

To further analyze the ability of TAA to induce an auxin response in tobacco, seedlings from transgenic tobacco plants expressing reporter gene RFP (red fluorescent protein gene) under the control of DR5 promoter were treated with different concentrations of TAA and compared the pattern of RFP fluorescence to that generated by equimolar concentration of other reported auxins over time.

Induction of an auxin response by TAA was analyzed by detecting the expression of fluorescent reporter gene under the control of auxin response elements (AuxRE) in transgenic tobacco. Plant transformation vector DR5rev::erRFP carrying DsRED reporter gene under an auxin-responsive promoter was obtained from addgene (www.addgene.org, plasmid ID. 61011). The plasmid was introduced into the Agrobacterium strain LBA4404, using freeze-thaw transformation. Transgenic plants were selected on a medium containing 25 mg/L hygromycin and then verified by PCR (polymerase chain reaction). The rooted plants were grown in soil and PCR positive tobacco seedlings were used in further experiments.

### Experiment 5 Results

DR5rev::erRFP transgenic tobacco seedlings were sensitive to exogenous TAA treatment. Auxin reporter gene expression was observed in primary root tips of transgenic tobacco seedlings within 30 minutes of treatment for all concentrations of TAA analyzed indicating elevated auxin levels. No detectable RFP was observed in either control WT (wild type) seedlings treated with different concentrations of TAA or in transgenic seedlings treated with equal volume of DMSO (dimethyl sulfoxide). With increasing TAA concentrations, the signal at the root tip was gradually increased confirming the dose-dependent auxin response to TAA levels.

With increase in time of treatment, fluorescence spread from tip to other parts of the root, and by 48 h of treatment, RFP signal was observable in secondary roots as well. Faint RFP was detectable in the areal parts of the plants after 48 h of treatment. Treatment of seedlings with equimolar concentrations of TAA and other auxins showed that the visual intensity of RFP fluorescence was similar to that produced by IAA and IBA.

To analyze the stability and dynamic distribution of auxin response in vivo upon treatment with TAA, transgenic seedlings were subjected to short-term treatment with TAA and observed patterns of RFP over a period of time. Free auxin levels in plants are maintained by their metabolism (biosynthesis, conjugation, and degradation) and transport. RFP was detectable in roots even after 48 h of TAA withdrawal. However, the fluorescence intensity was lower than that of continued TAA treatment. Similar to continued treatment, fluorescence which was only visible in the root tips initially spread to other parts over time. The experiment indicated that at least some of the TAA entered was metabolically active in vivo for the duration of the experiment.

Similar to previous results reported in tomato, TAA positively influenced shoot and shoot regeneration from tobacco leaf explants in vitro. An auxin response upon exogenous TAA application was apparent in transgenic tobacco seedlings by the expression of the reporter gene under the control of auxin-response elements. TAA is therefore usable to regenerate roots and shoots of the plant family Solanaceae, the family to which tomato and tobacco belong.

### Analysis of the Effect of TAA on Arabidopsis

Arabidopsis is a genus that belongs to the plant family Brassicaceae. The inventors have investigated the effect of TAA on the regulation of Arabidopsis, supporting the assertion that TAA is suitable for plant growth regulation for plants that have an auxin response, and for plants across an entire plant family.

Other plants within the Brassicaceae family exhibit similar auxin responses, and therefore TAA would also be suitable for use as a plant growth regulator for other plants within the family.

Arabidopsis Columbia-0 wild type (WT) was used for assessing the effect of TAA on root growth and its effects on the expression of auxin-responsive genes. Seeds of A. thaliana were surface sterilized by suspending in 70% ethanol for 1 minute, followed by treatment with 10% bleach for 20 minutes. After thorough washing with sterile distilled water, the sterilized seeds were plated onto germination medium (half-strength Murashige and Skoog basal medium with vitamins (1/2 MS) medium supplemented with 1% sucrose and 0.7% plant agar) for germination. Germination was initiated by incubating the seeds in darkness at 5° C. for 2 days, followed by transfer to a light environment at 22° C. with a photoperiod of 16-h light/8-h dark for further growth. Stock solutions of TAA were prepared in DMSO (dimethyl sulfoxide). In control treatments, DMSO was used in equal amounts as present in the greatest concentration of TAA tested.

### Experiment 6 Materials and Method

To analyze the effect of TAA on root growth, WT Arabidopsis seedlings were germinated as described and uniform-looking 8-day-old seedlings were transferred to germination medium supplemented with different concentrations of TAA (0.1, 1, 2, 5, 10, 25, 50, and 100 μM) or NAA/IAA/IBA (0.05, 0.1, 1, 2 and 5 μM). For IBA, two additional concentrations (10 and 25 μM) were also analyzed. Seedlings grown on media supplemented with an equal volume of DMSO were used as control. The seedlings were allowed to grow for 6 days and the plates were photographed at 24 h intervals. Primary root length was measured using Image J software. The difference in the number of lateral roots (LR) and root hairs was visually observed. Microscopic images were taken on a Leica Thunder Imager System (Leica Microsystems Ltd., Switzerland) and the images were processed with LAS X software.

### Experiment 6 Results

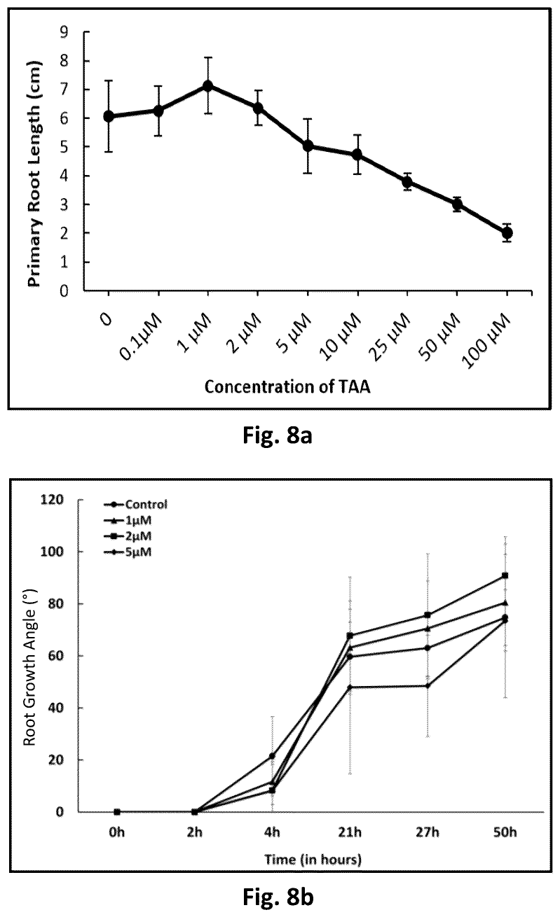

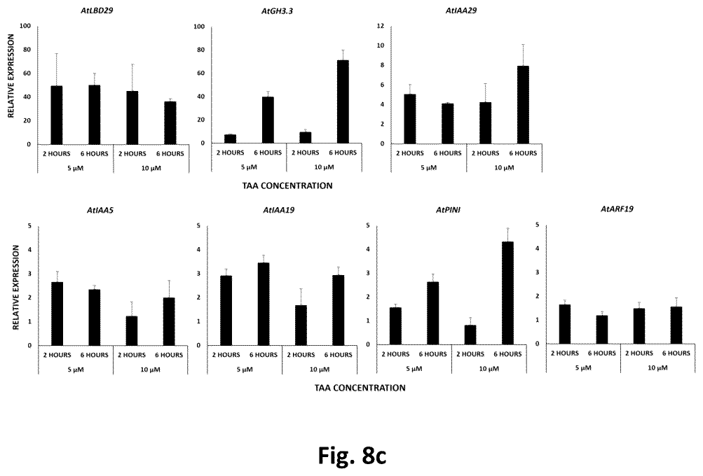

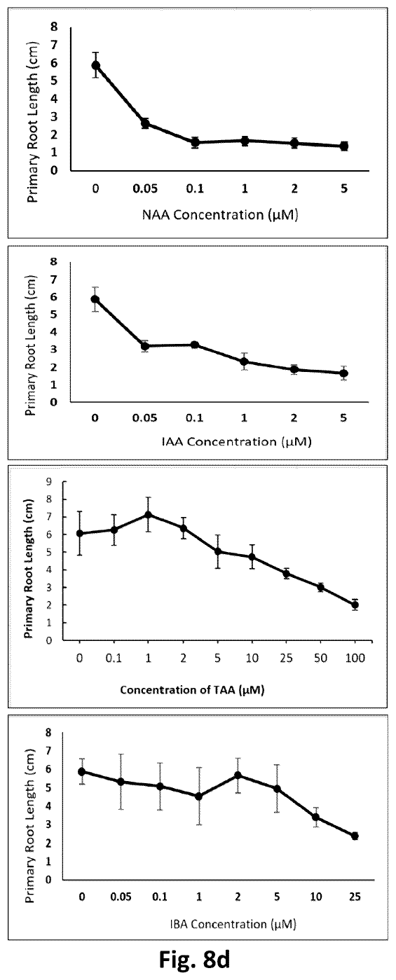

In embodiments, auxin exerts an inhibitory role on primary root growth while increasing the number of lateral roots (LR) and root hairs in a dose-dependent manner. To further characterize the ability of TAA to induce an auxin response, the effect of different concentrations of TAA on root growth and architecture of WT Arabidopsis was analyzed as shown in FIG. 8a. FIG. 8a shows that there is a promoter role of the TAA on the primary root length within a low concentration range. As the concentration of the TAA increases, the root growth of Arabidopsis decreases and at these concentration ranges TAA exhibits an inhibitory role.

Treatment of 8-day-old seedlings of WT A. thaliana seedlings with different concentrations of TAA show a clear concentration-dependent inhibitory effect on primary root growth. After 6 days of 50 μM TAA treatment, the length of the primary root was 50% of that in control. It is observed that the number of LRs increased at lower concentrations of TAA, indicating a positive effect on LR development. Higher concentrations (5 μM and above) reduced the number of LR and inhibited the elongation of LR.

The effect of TAA on root growth to that of other auxins was compared as shown in FIG. 8d. Similar to the effect shown by TAA, lower concentrations increased the number of lateral roots, but higher concentrations reduced their number and inhibited the LR elongation. The number of root hairs increased with concentration. The concentration that reduced the primary root length to 50% of control was 0.1 μM for IAA, 0.05 UM for NAA and 10 μM for IBA.

These results demonstrate that TAA induces an auxin response in plants that have an auxin response pathway.

### Experiment 7 Materials and Method

To analyze the effect of TAA on root growth in the presence of NPA (N-1-naphthylphthalamic acid), WT Arabidopsis seedlings were germinated as described and uniform-looking 8-day-old seedlings were transferred to germination medium supplemented with different concentrations of TAA (5 and 10 μM) and different concentrations of NPA (0, 0.5, 1, 2, 4, and 8 μM). The seedlings were allowed to grow for 6 days and the plates were photographed at 24 h intervals. Growth of lateral roots and root hair was observed visually.

### Experiment 7 Results

Root hair growth is influenced by internal auxin levels in the root hair cell. Increased auxin efflux inhibits root hair growth while an increase in auxin influx enhances root hair growth. N-1-naphthylphthalamic acid (NPA) inhibits auxin efflux by binding and inhibiting the activity of auxin efflux transporters of the PIN-FORMED (PIN) family. Treatment of WT Arabidopsis plants with NPA reduces primary root length and number of LRs and increases the number of root hairs in a concentration-dependent manner. Exogenous application of auxin reverses the inhibitory effects of NPA on lateral root density. Visual observation showed that NPA application reduced primary root length and the number of LR even at low concentrations (0.5 μM). Increasing NPA concentrations increased its inhibitory effects and higher concentrations severely limited shoot growth as well. Visual observation indicated that the addition of 5 μM of TAA increased the number of root hairs at all NPA concentrations analyzed, and at higher NPA concentrations supplemented with 5 μM of TAA, the increase in root hair density was much more prominent. Similar results were obtained when different NPA concentrations were supplemented with a higher concentration (10 μM) TAA.

The increased root hair density in plants treated with both NPA and TAA compared to those treated with them individually points towards increased TAA content in the root hair cells for the former.

### Experiment 8 Materials and Method

Gravitropism is the process whereby plants orientate their organ growth in response to gravity. This can be negative gravitropism (upward growth of shoots) or positive gravitropism (downward growth of roots). Auxin regulates gravitropism through polar auxin distribution mediated by asymmetric distribution of auxin transport carriers.

To analyze the effect of TAA on gravitropism, WT A. thaliana seeds were cultured on 1/2 MS medium for 8 days. Uniform seedlings were then selected and vertically grown in germination medium supplemented with different concentrations of TAA (1, 2, 5, 10, and 25 μM) for 24 h. Seedlings grown on media supplemented with DMSO were used as control. The plates were then rotated clockwise 90° to make the root parallel to the ground. The seedlings were allowed to grow for 73 h and the plates were photographed at different intervals. Image J software was used to measure the curvature of 16 plants each in the control and treatment groups.

### Experiment 8 Results

The effect of TAA on gravitropism on WT Arabidopsis seedlings was analyzed by rotating the seedlings grown vertically on media containing different concentrations of TAA by 90 degrees, making the roots parallel to the ground and observing the angle of root curvature over a period of time. The results showed that TAA enhanced the rate of gravitropic response at lower concentrations, as shown in FIG. 8b.

At initial time point after treatment (4 h), the growth angle of the roots of control plants was more than that of TAA-treated plants, but at later time points, reorientation of roots of plants treated with lower concentrations of TAA (1 and 2 μM) was higher. The growth angle continued to increase with continued root growth, and when final measurements were taken at 50 h after treatment, the primary roots of TAA-treated plants had bent to an angle close to 90° (FIG. 8b). Higher concentrations of TAA (5, 10 and 25 μM) did not show a marked change in growth angle, possibly due to the inhibitory effect of increased concentration off TAA on root growth.

### Experiment 9 Materials and Method

To analyze TAA responsive genes in Arabidopsis, WT Arabidopsis seeds were germinated as described and 14-day-old uniform-looking seedlings were initially acclimatized in liquid germination medium for 2 hours before transferring to medium containing different concentrations of TAA (5 and 10 μM). Seedlings in media supplemented with DMSO were used as control. Five random seedlings were selected and considered as one sample and three samples from both control and treatments were flash frozen in liquid nitrogen and total RNA was isolated using a TRIzol reagent (ThermoFisher Scientific, Cat #15596026).

Expression levels of seven previously reported early auxin-responsive genes were verified by qRT-PCR (quantitative reverse transcription polymerase chain reaction). RNA reverse transcription was performed using QuantiTect Reverse Transcription Kit (Qiagen). Three biological replicates and three technical replicates were used for all qRT-PCRs. Arabidopsis actin gene (AT3G18780) was used as internal reference.

### Experiment 9 Results

Expression patterns of seven previously reported early auxin-responsive genes was analyzed in response to different concentrations of TAA. PIN family of auxin efflux carriers, localized in the plasma membrane (PM) or endoplasmic reticulum (ER), plays a central role in the asymmetric distribution of auxin in plants. A. thaliana PIN1 (AT1G73590) is an early responsive PM-localized gene contributing to cell-to-cell auxin transport and its expression pattern in the root meristem accurately reflects changes in auxin content.

The results showed concentration and time-dependent increase in AtPIN1 gene expression. Higher concentration of TAA (10 μM) initially led to a slight decrease in expression level at 2 h compared to treatment with 5 μM TAA before it increased to nearly five-fold after 6 hours, as shown in FIG. 8c.

The results showed high upregulation of (over 70 fold) AtGH3.3 (AT2G23170) upon treatment with TAA in a concentration and time-dependent manner. Endogenous auxin levels are tightly controlled to limit the inhibitory effects of higher concentrations. The high expression levels of AtGH3.3 indicate that TAA levels used in the experiment are inhibitory and AtGH3.3 has the potential to conjugate Aspartate to TAA as a means of degrading it.

The expression levels of three IAA genes ((AtIAA5 (AT1G15580), AtIAA19 (AT3G15540), AtIAA29 (AT4G32280)) upon exposure to TAA were analyzed. Aux/IAA proteins are auxin-responsive and contribute an important role to auxin signaling by serving as transcriptional repressors of ARFs (auxin response factors). AtIAA5, AtIAA19 and AtIAA29 are primary auxin-responsive genes and are inducible by auxin treatments. IAA5, IAA19 and IAA29 are involved in callus and lateral root formation and their induction upon treatment with 5 and 10 μM TAA correlates with increased lateral root formation under the same concentrations (FIG. 8c).

LATERAL ORGAN BOUNDARIES DOMAIN (LBD) transcription factor 29 (AtLBD29, AT3G58190) and ARF19 (AtARF19, AT1G19220) which is involved in regulating its expression are early auxin-inducible and involved in auxin-induced ectopic activation of root developmental programs. The results show upregulation of both these genes under the concentration of TAA analyzed at both time points. Overall, the real-time PCR results show upregulation of auxin inducible genes under TAA treatment (FIG. 8c).

It is clear that TAA is able to produce an auxin response in plants that have an auxin response pathway. In embodiments, TAA is able to produce an auxin response in the plant species Solanaceae and Brassicaceae. Both those plant species have been shown to have an auxin response pathway that responds to TAA (and other auxins), and therefore a plant growth regulator comprising TAA would be suitable for regulating the growth of plants belonging to Solanaceae and Brassicaceae.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. The disclosures and the description herein are intended to be illustrative and are not in any sense limiting the present disclosure, defined in scope by the following claims.

Many changes, modifications, variations and other uses and applications of the present disclosure will become apparent to those skilled in the art after considering this specification and the accompanying drawings, which disclose the preferred embodiments thereof. All such changes, modifications, variations and other uses and applications, which do not depart from the spirit and scope of the present disclosure, are deemed to be covered by the invention, which is to be limited only by the claims which follow.

1. A plant growth regulator composition for regulating the growth of roots and shoots of explants with an auxin response pathway in vitro comprising thiophene acetic acid.

2. A plant growth regulator composition according to claim 1, wherein the thiophene acetic acid is thiophene-3-acetic acid.

3. A plant growth regulator composition according to claim 1, wherein the plant growth regulator composition is a plant growth regulator composition for regenerating the roots and shoots of explants with an auxin response pathway.

4. A plant growth regulator composition according to claim 1, wherein the plant growth regulator is a plant growth-inhibitor.

5. A plant growth regulator composition according to claim 1, wherein the plant growth regulator further comprises 6-benzylaminopurine and/or other cytokinins.

6. A plant growth regulator composition according to claim 5, wherein the concentration of 6-benzylaminopurine (BAP) is between 0.5 mg/L and 2.0 mg/L.

7. A plant growth regulator composition according to claim 6, wherein the concentration of BAP is between 0.75 mg/L and 1.25 mg/L.

8. A plant growth regulator composition according to claim 1, wherein the concentration of thiophene acetic acid is greater than 0.05 mg/L.

9. A plant growth regulator composition according to claim 8, wherein the concentration of thiophene acetic acid is between 0.05 mg/L and 50 mg/L.

10. A plant growth regulator composition according to claim 9, wherein the concentration of thiophene acetic acid is between 0.5 mg/L and 25 mg/L.

11. A plant growth regulator composition according to claim 10, wherein the concentration of thiophene acetic acid is between 1 mg/L and 15 mg/L.

12. A plant growth regulator composition according to claim 11, wherein the plant growth regulator composition further comprises BAP at a concentration between 0.5 mg/L and 2 mg/L.

13. A plant growth regulator composition according to claim 1, wherein the explants belong to one or more of the plant families Solanaceae or Brassicaceae.

14. A method of regulating growth of roots and shoots of explants with an auxin response pathway, the method comprising:
preparing a plant growth regulator composition comprising thiophene acetic acid according to claim 1; and
contacting the explants and the plant growth regulator composition in vitro.

15. A method of regulating growth of plants according to claim 14, wherein the preparing comprises forming a culture media comprising the plant growth regulator composition such that the concentration of thiophene acetic acid is greater than 0.05 mg/L, and the contacting comprises placing the explants in the culture media.

16. A method of regulating growth of plants according to claim 15, wherein the culture media further comprises Murashige and Skoog (MS) medium.

17. A method of regulating growth of plants according to claim 15, wherein the culture media further comprises sucrose gelled with agar.

18. A method of regulating growth of roots and shoots of plants with an auxin response pathway, the method comprising:
preparing a plant growth regulator composition comprising thiophene acetic acid according to claim 1; and
watering the explants with a solution comprising the plant growth regulator composition.

19. A fertilizer for regulating growth of roots and shoots of plants with an auxin response pathway, the fertilizer comprising a plant growth regulator composition according to claim 1.
